(19) United States
(12) Patent Application Publication
(10) Pub. No.: US 2008/0239509 A1
(43) Pub. Date: Oct. 2, 2008

(54) Compact imaging lens assembly for an imaging-based bar code reader

(75) Inventor: Igor Vinogradov, New York, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Symbol Technologies, Inc., Holtsville, NY (US)

(21) Appl. No.: 11/731,835

(22) Filed: Mar. 30, 2007

(51) Int. Cl. G02B 9/02; G02B 3/02; G02B 3/12

(52) U.S. Cl. 359/709; 359/665; 359/793

(57) ABSTRACT

An imaging lens assembly (30) for a camera assembly (20) of an imaging-based bar code reader (10) for focusing an image (100′) of a target object (100) within a field of view (FV) of the camera assembly (20) onto a sensor array (28) of the camera assembly (20). The imaging lens assembly includes a front aperture stop (31) facing the field of view (FV), the aperture stop (31) including an aperture (31a) through which light from the field of view (FV) passes. The imaging lens assembly (30) further including a three lens system (36) disposed rearward of the front aperture stop (31) and a meniscus lens (35) disposed rearward of the three lens system (36). The three lens system (36) and the meniscus lens (35) receiving light passing through the aperture (31a) and focusing the light onto the sensor array (28).

### FIELD OF THE INVENTION

The present invention relates to an imaging lens assembly for an imaging-based bar code reader and, more particularly, to a compact imaging lens assembly for focusing reflected illumination from an object of interest within a field of view of the imaging lens assembly onto a sensor array of the bar code reader, the imaging lens assembly including a front aperture stop, a three lens system and a negative meniscus lens.

### BACKGROUND ART

Various electro-optical systems have been developed for reading optical indicia, such as bar codes. A bar code is a coded pattern of graphical indicia comprised of a series of bars and spaces of varying widths, the bars and spaces having differing light reflecting characteristics. Some of the more popular bar code symbologies include: Uniform Product Code (UPC), typically used in retail stores sales; Code 39, primarily used in inventory tracking; and Postnet, which is used for encoding zip codes for U.S. mail. Bar codes may be one dimensional (1D), i.e., a single row of graphical indicia such as a UPC bar code or two dimensional (2D), i.e., multiple rows of graphical indicia comprising a single bar code.

Systems that read bar codes (bar code readers) electro-optically transform the graphic indicia into electrical signals, which are decoded into alphanumerical characters that are intended to be descriptive of the article or some characteristic thereof. The characters are then typically represented in digital form and utilized as an input to a data processing system for various end-user applications such as point-of-sale processing, inventory control and the like.

Bar code readers that read and decode bar codes employing imaging systems are typically referred to as imaging-based bar code readers or bar code scanners. Imaging systems include charge coupled device (CCD) arrays, complementary metal oxide semiconductor (CMOS) arrays, or other imaging sensor arrays having a plurality of photosensitive elements (photosensors) or pixels. An illumination apparatus or system comprising light emitting diodes (LEDs) or other light source directs illumination toward a target object, e.g., a target bar code. Light reflected from the target bar code is focused through an assembly of one or more lens onto the sensor array. Thus, the target bar code within a field of view (FV) of the imaging lens assembly is focused on the sensor array.

Periodically, the pixels of the sensor array are sequentially read out generating an analog signal representative of a captured image frame. The analog signal is amplified by a gain factor and the amplified analog signal is digitized by an analog-to-digital converter. Decoding circuitry of the imaging system processes the digitized signals representative of the captured image frame and attempts to decode the imaged bar code.

As mentioned above, imaging-based bar code readers typically employ an imaging lens assembly for focusing reflected illumination from an object of interest within the field of view (FV) onto the sensor array. Typically, the imaging lens assembly includes an aperture stop and a plurality of lens located along an optical axis of the lens assembly on both sides of an aperture stop defining an aperture or opening of predetermined size and shape. In typical imaging lens assemblies, there are lens located both forward and rearward of the aperture, that is, a plurality of lens are located forward (toward the target bar code) of the aperture and a plurality of lens are located rearward of the aperture between the aperture and the sensor array. An example of a bar code reader employing an imaging lens assembly having a plurality of lens on both sides of an aperture stop is found in U.S. Pat. No. 5,793,033 to Feng et al., which is incorporated herein in its entirety by reference.

A typical imaging lens assembly includes a multiplicity of lens to properly focus reflected illumination from an object, such as a target barcode, within the field of view onto the sensor array. For efficient and accurate decoding of a target bar code, a well focused, sharp image of the target bar code must be projected onto the sensor array. However, because the imaging lens assembly is typically enclosed within a camera module or assembly, space within the module is extremely limited and designers are continually seeking to reduce the size of the camera module. Since the imaging lens assembly is positioned along its optical axis between the sensor array and the front of the camera assembly, a distance along the optical axis occupied by the imaging lens assembly is of great concern to designers seeking to minimize the size of the camera assembly.

Thus, what is needed is an imaging lens assembly that reduces a total distance along an optical axis that is occupied by the imaging lens assembly to minimize the size of the camera module.

Additionally, it is desirable to have access to the aperture stop, for example, to add an optical element by attaching it to the aperture stop. Thus, it would also be desirable to have the aperture plate at the forward or target facing end of the imaging lens assembly.

### SUMMARY

In one aspect, the present invention features an imaging lens assembly for a camera assembly of an imaging-based bar code reader for focusing an image of a target object within a field of view of the camera assembly onto a sensor array of the camera assembly. The imaging lens assembly includes:

a front aperture stop facing the field of view of the camera assembly, the aperture stop including an aperture through which light from the field of view passes;

a three lens system disposed rearward of the front aperture stop, the three lens system including a first lens closest to the front aperture stop having a positive optical power, second middle lens having a negative optical power and a third lens having a positive optical power; and

a negative meniscus lens disposed rearward of the three lens system, a curvature of a forward facing optic surface facing the three lens system being different than a curvature of a rearward facing optic surface, the three lens system and the negative meniscus lens receiving light passing through the aperture and focusing the light onto the sensor array.

In one embodiment, a radius of curvature of the forward facing optic surface of the negative meniscus lens is less than a radius of curvature of the rearward facing optic surface.

In one aspect, the present invention features an imaging-based bar code reader including:

an imaging system including camera assembly including an imaging lens assembly and a sensor array for focusing an image of a target object within a field of view onto the sensor array;

the imaging lens assembly including:

a front aperture stop facing the field of view of the camera assembly, the aperture stop including an aperture through which light from the field of view passes;

a three lens system disposed rearward of the front aperture stop, the three lens system including a first lens closest to the front aperture stop having a positive optical power, second middle lens having a negative optical power and a third lens having a positive optical power; and

a negative meniscus lens disposed rearward of the three lens system, a curvature of a forward facing optic surface facing the three lens system being different than a curvature of a rearward facing optic surface, the three lens system and the negative meniscus lens receiving light passing through the aperture and focusing the light onto the sensor array.

In one embodiment, a radius of curvature of the forward facing optic surface of the negative meniscus lens is less than a radius of curvature of the rearward facing optic surface.

These and other objects, advantages, and features of the exemplary embodiments are described in detail in conjunction with the accompanying drawings.

### BRIEF DESCRIPTION OF THE DRAWINGS

The foregoing and other features and advantages of the present invention will become apparent to one skilled in the art to which the present invention relates upon consideration of the following description of the invention with reference to the accompanying drawings, in which:

FIG. 1 is a schematic side elevation view of an exemplary embodiment of an imaging-based bar code reader of the present invention;

FIG. 2 is a schematic front elevation view of the bar code reader of FIG. 1;

FIG. 3 is a schematic top plan view of the bar code reader of FIG. 1;

FIG. 3A is a schematic top plan view of a modular camera assembly of the bar code reader in FIG. 1 showing a portion of the assembly labeled as FIG. 3A in dashed line in FIG. 3;

FIG. 4 is a schematic view partly in section and partly in side elevation of a camera assembly of an imaging assembly of the bar code reader of FIG. 1;

FIG. 5 is a schematic block diagram of the bar code reader of FIG. 1;

FIG. 6 is a schematic side elevation view of an exemplary embodiment of an imaging lens assembly of the present invention;

FIG. 7 is a schematic side elevation view of a second exemplary embodiment of the imaging lens assembly including an axicon lens; and

FIG. 8 is a schematic side elevation view of a third exemplary embodiment of the imaging lens assembly including a liquid lens.

### DETAILED DESCRIPTION

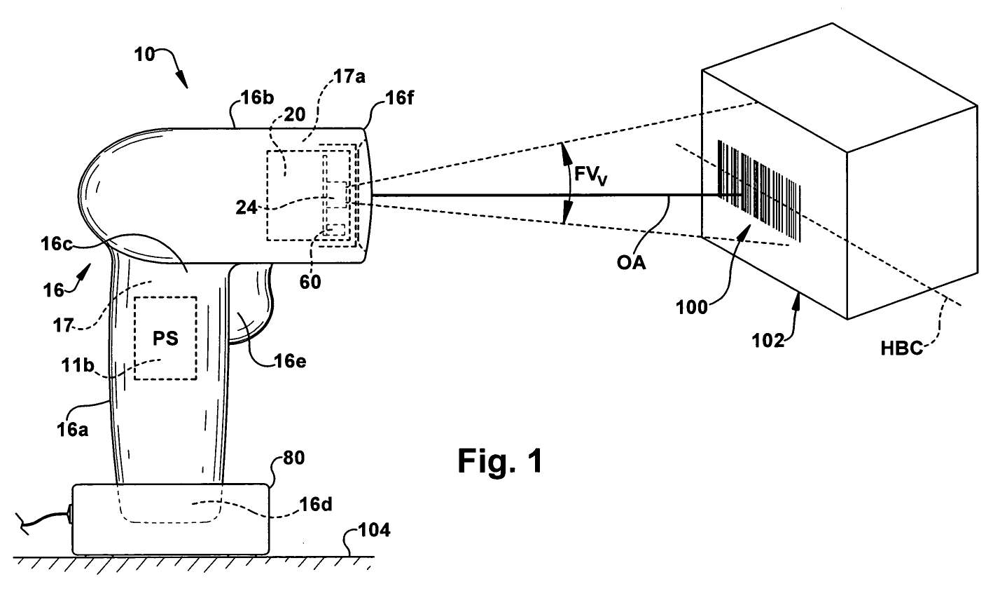

An exemplary embodiment of an imaging-based bar code reader of the present invention is shown schematically at 10 in FIGS. 1-5. The bar code reader 10 includes an imaging system 12 and a decoding system 14 mounted in a housing 16. The reader 10 is capable of reading, that is, imaging and decoding target objects of interest, such as bar codes, postal codes, signatures, etc. The imaging system 12 includes a modular imaging camera assembly 20 adapted to capture image frames within a field of view FV of the camera assembly 20. The decoding system 14 is adapted to decode encoded indicia within captured image frames. The housing 16 supports circuitry 11 of the reader 10 including the imaging and decoding systems 12, 14 within an interior region 17 of the housing 16.

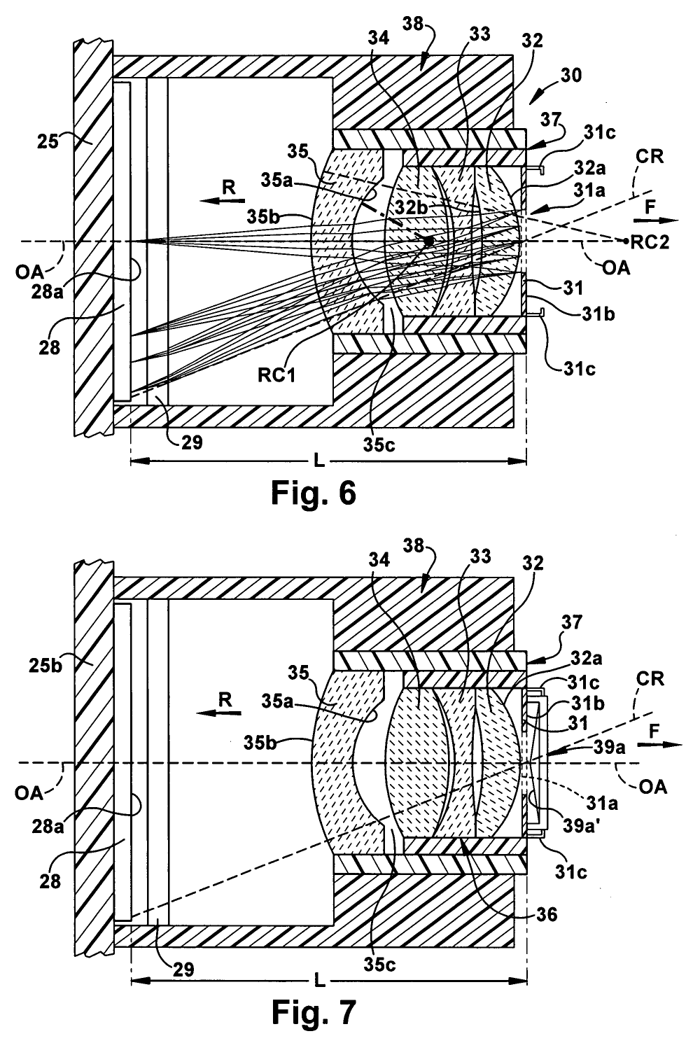

The imaging system 12 comprises the modular imaging camera assembly 20 and associated imaging circuitry 22. The imaging camera assembly 20 is includes a housing 24 supporting a sensor array 28 and an imaging lens apparatus or assembly 30 that focuses light from the field of view FV onto the sensor array 28. The camera assembly 20 may, but does not have to be, modular in that the housing 24 may be removed or inserted as a unit into the reader 10, allowing the ready substitution of camera assemblies having different imaging characteristics, e.g., camera assemblies having different working ranges and different fields of view. A working range is a distance range in front of or forward (in a direction F in FIG. 6) of the camera assembly 20 within which an object of interest such as a target bar code may be successfully imaged and decoded.

The sensor array 28 is enabled during an exposure period to capture an image of the field of view FV of the imaging system 12. The field of view FV and the working range of the imaging system 12 are a function of both the configuration of the sensor array 28 and the optical characteristics of the imaging lens assembly 30 and the distance and orientation between the array 28 and the imaging lens assembly 30.

In one exemplary embodiment, the imaging system 12 is adapted to read both 1D and 2D bar codes and the sensor array 28 is a 2D sensor array. The imaging circuitry 22 may be disposed within, partially within, or external to the camera assembly housing 24.

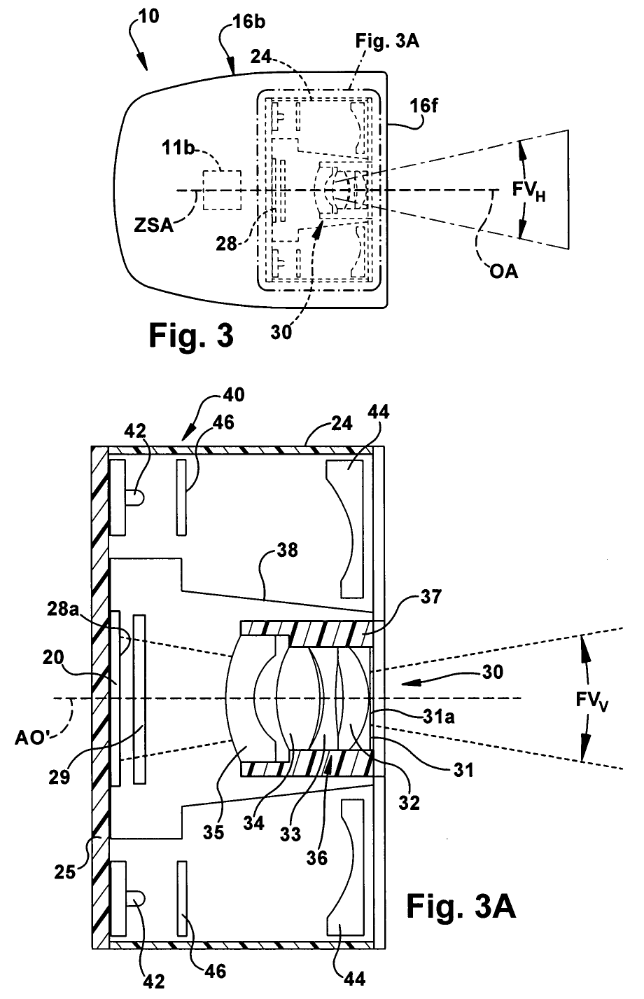

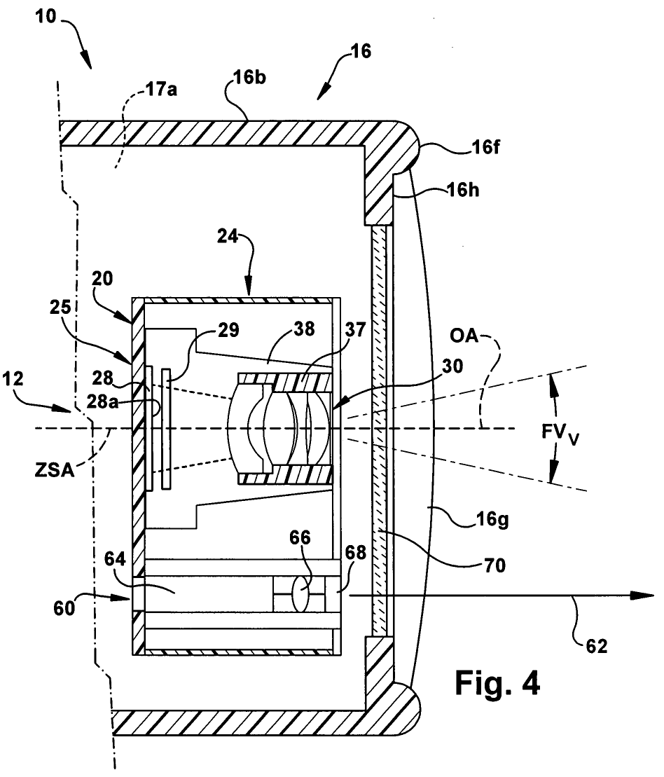

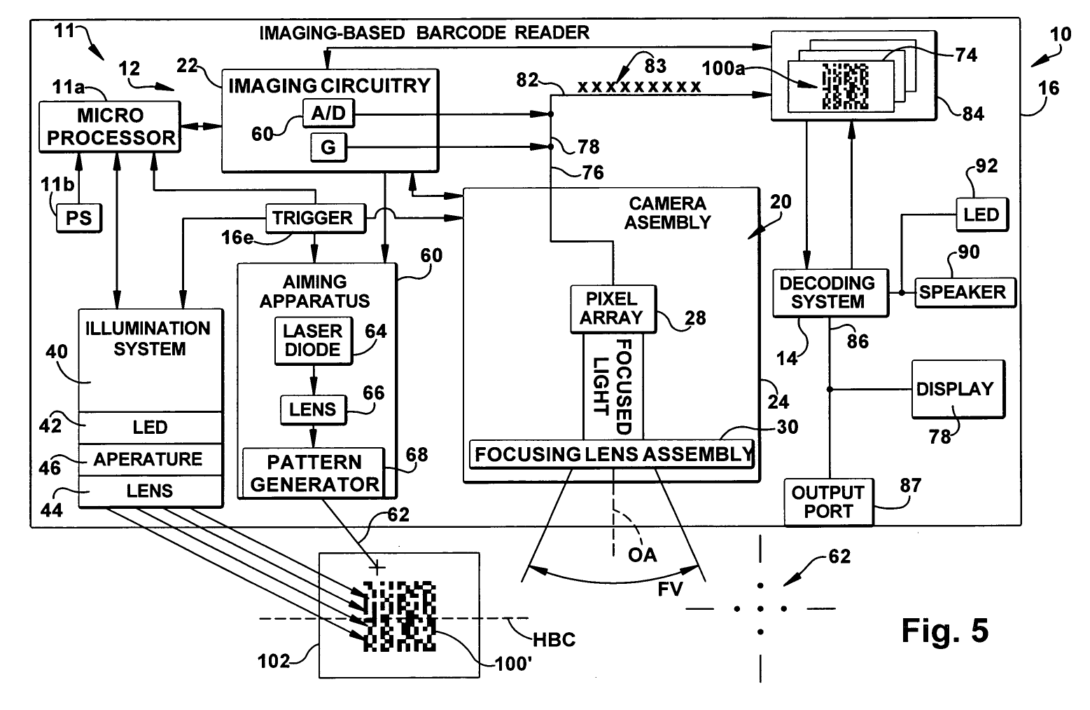

The camera assembly 20 field of view FV (shown schematically in FIG. 5) includes both a horizontal and a vertical field of view, the horizontal field of view being shown schematically as FVH in FIG. 3 and the vertical field of view being shown schematically as FVV in FIGS. 1 and 4. The imaging system 12 is adapted to image 1D and 2D encoded indicia, such as 1D and 2D bar codes, postal codes, signatures, etc. In FIG. 1, the reader 10 is reading a target object, such as a bar code 100, affixed to a product or package 102. The target bar code 100 extends along a horizontal axis HBC. One exemplary target bar code 100 (shown in FIG. 1) is a 1D bar code having a single row of indicia, that is, a single row of dark bars and white spaces. A second exemplary target bar code 100′ (shown in FIG. 5) is a 2D bar code having multiple rows of indicia, that is, an array of dark bars and white spaces. The decoding system 14 is adapted to decode the image of the encoded indicia of the target bar code 100, 100′ provided, of course, that the target bar code 100, 100′ was within both the field of view FV and the working range of the imaging system 12.

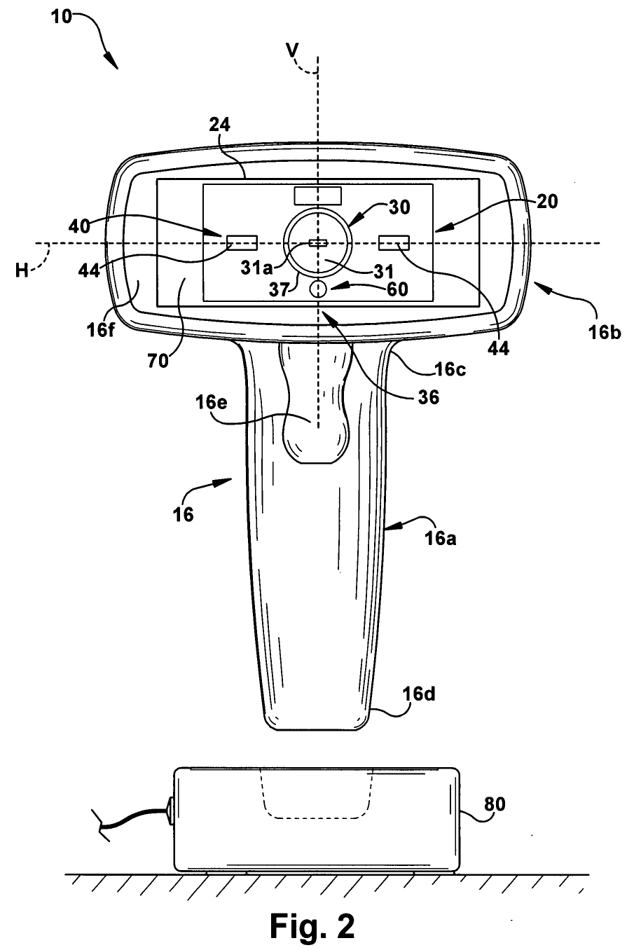

The housing 16 includes a gripping portion 16a adapted to be grasped by an operator's hand and a forward or scanning head portion 16b extending from an upper part 16c of the gripping portion 16a. A lower part 16d of the gripping portion 16a is adapted to be received in a docking station 80 positioned on a substrate 104 such as a table or sales counter. The scanning head 16b supports the imaging system 12 within an interior region 17a (FIG. 4) of the scanning head 16b. As can best be seen in FIG. 2, looking from the front of the housing 16, the scanning head 16b is generally rectangular in shape and defines a horizontal axis H and a vertical axis V. The vertical axis V being aligned with a general extent of the gripping portion 16a.

The camera housing 24 is supported within the scanning head interior region 17a in proximity to a transparent window 70 defining a portion of a front wall 16f of the scanning head 16b. The window 70 is oriented such that its horizontal axis is substantially parallel to the scanning head horizontal axis H and its vertical axis is substantially parallel to the scanning head vertical axis V. Illumination or light from the field of view FV, including reflected light from the target bar code 100, passes through the transparent window 70, is received by the focusing lens assembly 30 and focused onto the imaging system sensor array 28.

Advantageously, the reader 10 of the present invention is adapted to be used in both a hand-held mode and a fixed position mode. In the fixed position mode, the housing 16 is received in the docking station 80 and the target object 102 having the target bar code 100 (FIG. 1) is brought within the field of view FV of the reader's imaging system 12 in order to have the reader 10 read the target bar code 100. The imaging system 12 is typically always on or operational in the fixed position mode to image and decode any target bar code presented to the reader 10 within the field of view FV. The docking station 80 is plugged into an AC power source and provides regulated DC power to circuitry 11 of the reader 10. Thus, when the reader 10 is in the docking station 80 power is available to keep the imaging system 12 on continuously.

In the hand-held mode, the housing 14 is removed from the docking station 80 so the reader 10 can be carried by an operator and positioned such that the target bar code 100 is within the field of view FV of the imaging system 12. In the hand-held mode, imaging and decoding of the target bar code 100 is instituted by the operator depressing a trigger 16e extending through an opening near the upper part 16c of the gripping portion 16a.

The imaging system 12 is part of the bar code reader circuitry 11 which operates under the control of a microprocessor 11a (FIG. 5). When removed from the docking station 80, power is supplied to the imaging and decoding systems 12, 14 by a power supply 11b. The imaging and decoding systems 12, 14 of the present invention may be embodied in hardware, software, electrical circuitry, firmware embedded within the microprocessor 11a or the modular camera assembly 20, on flash read only memory (ROM), on an application specific integrated circuit (ASIC), or any combination thereof.

The bar code reader 10 includes an illumination apparatus or system 40 to illuminate the field of view FV, including the target bar code 100, and an aiming system 60 which generates a visible aiming pattern 62 (FIG. 5) to aid the operator in aiming the reader 10 at the target bar code 100 when using the reader in the hand-held mode. The illumination apparatus 40 includes a pair of illumination sources 42 such as an LED, such as a surface mount LED, or a cold cathode lamp (CFL) which is energized to direct illumination though respective focusing lens 44 and generate an illumination pattern that fills or substantially coincides with the field of view FV of the imaging system 12.

An aperture 46 defining an opening 46a is positioned between the LED 42 and the focusing lens 44. The aperture 46 limits the light or illumination from the LED focused onto the focusing lens 44. The focusing lens 44 images or projects the general shape of the aperture 46 toward the target object 102 thus defining the illumination pattern. The aperture 46 is in proximity to a focal plane of the focusing lens 44. The light from the aperture opening 46a is collected and focused by the focusing lens 44.

A vertical size or dimension of the aperture 46 determines the vertical extent of the illumination pattern projected on the target object 102. While the illumination assembly 40 shown in the exemplary embodiment of the reader 10 includes a pair of illumination sources 42, it should be understood that depending on the specifics of the reader and the environmental conditions under which the reader will be used, the number of illumination sources may be one, two, three or more.

The aiming system 60 generates the visible aiming pattern 62 comprising a single dot of illumination, a plurality of dots and/or lines of illumination or overlapping groups of dots/lines of illumination. The aiming system 60 typically includes a laser diode 64, a focusing lens 66 and a pattern generator 68 for generating the desired aiming pattern 62.

### Operation of Imaging and Decoding Systems 12, 14

When actuated to read the target bar code 100, the imaging system 12 captures a series of image frames 74 which are stored in a memory 84. Each image frame 74 includes an image 100a of the target bar code 34 (shown schematically in FIG. 5). The decoding system 14 decodes a digitized version of the imaged bar code 100a.

Electrical signals are generated by reading out of some or all of the pixels of the pixel array 28 after an exposure period. After the exposure time has elapsed, some or all of the pixels of pixel array 28 are successively read out thereby generating an analog signal 76 (FIG. 4). In some sensors, particularly CMOS sensors, all pixels of the pixel array 28 are not exposed at the same time, thus, reading out of some pixels may coincide in time with an exposure period for some other pixels.

The analog image signal 76 represents a sequence of photosensor voltage values, the magnitude of each value representing an intensity of the reflected light received by a photosensor/pixel during an exposure period. The analog signal 76 is amplified by a gain factor, generating an amplified analog signal 78. The imaging circuitry 22 further includes an analog-to-digital (A/D) converter 80. The amplified analog signal 78 is digitized by the A/D converter 80 generating a digitized signal 82. The digitized signal 82 comprises a sequence of digital gray scale values 83 typically ranging from 0-255 (for an eight bit processor, i.e., 2⁸=256), where a 0 gray scale value would represent an absence of any reflected light received by a pixel during an exposure or integration period (characterized as low pixel brightness) and a 255 gray scale value would represent a very high intensity of reflected light received by a pixel during an exposure period (characterized as high pixel brightness).

The digitized gray scale values 83 of the digitized signal 82 are stored in the memory 84. The digital values 83 corresponding to a read out of the pixel array 28 constitute the image frame 74, which is representative of the image projected by the focusing lens assembly 30 onto the pixel array 28 during an exposure period. If the field of view FV of the focusing lens assembly 30 includes the target bar code 34, then a digital gray scale value image 100a of the target bar code 100 would be present in the image frame 74.

The decoding circuitry 14 then operates on the digitized gray scale values 83 of the image frame 74 and attempts to decode any decodable image within the image frame, e.g., the imaged target bar code 100a. If the decoding is successful, decoded data 86, representative of the data/information coded in the bar code 100 is then output via a data output port 87 and/or displayed to a user of the reader 10 via a display 88. Upon achieving a good “read” of the bar code 34, that is, the bar code 34 was successfully imaged and decoded, a speaker 90 and/or an indicator LED 92 is activated by the bar code reader circuitry 11 to indicate to the user that the target bar code 100 has successfully read, that is, the target bar code 100 has been successfully imaged and the imaged bar code 100a has been successfully decoded. If decoding is unsuccessful, a successive image frame 74 is selected and the decoding process is repeated until a successful decode is achieved.

### Camera Assembly 20

As noted above, in one exemplary embodiment, the camera assembly 20 is modular, that is, the housing 24 may be removed or inserted as a unit into the housing scanning head 16b. This provides for ready substitution of camera assemblies having different imaging characteristics, e.g., camera assemblies having different working ranges and different fields of view.

In one exemplary embodiment, as can best be seen in FIG. 3A, the illumination apparatus 40 and the aiming assembly 60 are supported within the camera housing 24 along with the sensor array 28 and the imaging lens assembly 30, although it should be recognized that they may be external to the housing if desired. As the camera housing 24 is positioned adjacent to and behind the window 70, illumination from the illumination apparatus 40 and the aiming pattern 62 generated by the aiming assembly 60 pass through the window 70. Light within the imaging system field of view FV passes through the window 70 and is focused by the imaging lens assembly 30 onto the sensor array 28.

The camera assembly 20 includes the sensor array 28 which comprises a charged coupled device (CCD), a complementary metal oxide semiconductor (CMOS), or other imaging pixel array, operating under the control of the imaging circuitry 22. In one exemplary embodiment, the sensor array 28 comprises a 2D pixel CCD or CMOS array. By way of example only a typical size of the 2D sensor array 28 would be 1280×1024 pixels. It should also be appreciated that the present invention is equally suited to having a 1D or linear sensor array comprising a single row of pixels having, for example, 512, 1024, 2048 or 4096 pixels.

The illumination-receiving pixels of the pixel array define a sensor array surface 28a (best seen in FIG. 4). Positioned parallel to the sensor array surface 28a is a transparent sensor cover 29, such as a flat glass cover (FIG. 6). The pixel array 28 is secured to a printed circuit board 25, in parallel direction for stability. The printed circuit board 25 may comprise a back end of the housing 24 and constitutes part of the imaging circuitry 22. The printed circuit board 25 extends vertically downwardly to support the laser diode 64 of the aiming apparatus 60 (best seen in FIG. 4).

The sensor array surface 28a is substantially perpendicular to an optical axis OA of the focusing lens assembly 30, that is, a z axis (labeled ZSA in FIG. 4) that is perpendicular to the sensor array surface 28a would be substantially parallel to the optical axis OA of the focusing lens assembly 30. The pixels of the sensor array surface 28a are disposed substantially parallel to the horizontal axis H of the scanning head 16b. As the sensor array 28 and the imaging lens assembly 30 are both supported by the circuit board 25, the camera assembly 20 is sometimes referred to as a board camera.

### Imaging Lens Assembly 30

As is best seen in FIGS. 3A, 4, and 6, the focusing lens assembly 30 focuses light reflected and scattered from the object of interest such as the target bar code 100 onto the sensor array surface 28a, thereby focusing an image of the target bar code 100 (assuming it is within the field of view FV) onto the sensor array surface 28a. The imaging lens assembly 30 of the present invention is advantageously compact. A length or distance L (FIG. 6) measured along the optical axis OA from a front of the lens assembly 30 to the sensor array surface 28a, the distance L is shorter compared to typical lens assemblies. The front of the lens assembly 30 is defined by a forward facing surface 31b of the aperture stop 31.

As can best be seen in FIG. 6, the imaging lens assembly 30 includes four lenses 32, 33, 34, 35 which are positioned behind a front aperture stop 31. The front aperture stop 31 defines an aperture 31a, such as, for example, a circular or rectangular opening, which limits the light impinging upon or received by the lens assembly 30. In other words, the aperture 31a insures that the light that reaches a forwardly facing optic surface 32a of the first lens 32 is light generally within the bounds of the field of view FV. The field of view FV is generally rectangular and determined by the rectangular shape of the sensor array 28 and the focal distance of the imaging lens assembly 30.

The first three lenses 32, 33 and 34 define a three lens assembly or system 36. The first and third lens 32, 34 of the three lens system 36 are positive power lens which are preferably fabricated of crown glass and are characterized by a high Abbe value. The second lens 33 is a negative power lens which is fabricated of flint glass and is characterized by a low Abbe value. This lens system 26 is generally similar to Cooke type triplet lens where a three lens system includes first and third lenses with a positive optical power and a middle lens with a negative optical power. A Cooke triplet is different from the three lens system 36, however, because in a Cooke triplet, the light rays strike the middle lens close to the optical axis of the triplet system implying that an aperture is present adjacent the negative power middle lens, thus, in a Cooke triplet, the chief or central light ray strikes the optical axis within the bounds of the lenses of the Cooke's triplet. By contrast, in the three lens system 36 of the present invention, the chief ray CR strikes the optical axis OA at the aperture stop 31, which is outside the three lens system 36 but near the first lens 32. The chief ray CR is drawn in FIG. 6 and, as can be seen, intersects the optical axis OA at the aperture stop.

The first lens 32, as noted above, is a positive optical power lens. In one preferred embodiment, the first lens 32 (facing in the direction F in FIG. 6) is a convex-concave lens, the optical power of the convex optical surface 32a being of greater positive magnitude than a magnitude of a negative optical power of the concave optical surface 32b resulting a net positive optical power for the first lens 32. The second lens 33, as noted above, is a negative power optical lens. In one preferred embodiment, the second lens 33 is a biconcave lens, with both optic surfaces having negative optical power. The third lens 34, as noted above, is a positive optical power lens. In one preferred embodiment, the third lens 34 is a biconvex lens, with both optic surfaces having a positive optical power.

Positioned rearward (that is, in the direction R in FIG. 6) of the three lens assembly 36 is the fourth lens 35, which is a negative meniscus lens which has a negative optical power. In one preferred embodiment, an optical surface 35a facing the three lens system 36 (that is, forwardly facing in the direction F in FIG. 6) has negative optical power, while an optical surface 35b facing the sensor 28 has a positive optical power. The overall optical power of the meniscus lens 35 is negative. In particular, a radius of curvature RC1 of the forward optical surface 35a (that is, in the direction F in FIG. 6) is smaller in magnitude than a radius of curvature RC2 of the rearward optical surface 35b (that is, in the direction R in FIG. 6), hence, the overall or net optical power of the lens 35 is negative.

As can be seen in FIG. 6, preferably, there is a small air gap 35c between the negative meniscus lens 35 and the third lens 34 of the three lens system 36. The negative meniscus lens 35 is preferably is fabricated of crown glass and advantageously provides for more effectively minimizing the field curvature of the light focused onto the sensor array surface 28a. In general, field curvature refers to the fact that an imaging lens assembly (such as a Cooke's triplet or any other lens assembly) does not focus a perfectly sharp image of an object of interest such as bar code onto a flat plane, rather, the sharpest image of the bar code will lie on a curved surface. However, since the surface of the sensor array 28 is planar, it is desirable to minimize the field curvature of the light focused onto the sensor array 28 to as great extent as possible. Generally, the more lenses that are added to an imaging system, the more the field curvature is flattened or minimized at the sensor array 28. Adding more and more lenses to a lens assembly is not practical, however, because it increases the length L of the lens assembly which is highly undesirable. Stated another way, the four lenses 32, 33, 34, 35 work in combination such that the sum of the lens curvatures multiplied by the respective indices of refraction is substantially zero resulting in a substantially flat field of focus.

The imaging lens assembly 30 of the present invention strikes a good balance between a lens assembly that has a short overall length L between a front 31b of the lens assembly 30 and the sensor array surface 28a, while providing for enhanced performance in terms of a desirable flattened field of curvature at the sensor array 28. The flattened field of curvature at the sensor array 28 provides for a sharp image, that is, good resolution of the image 100a of the target bar code 100 on the sensor array surface 28a. In the imaging lens assembly 30 of the present invention, the three lens system 36, the presence of a negative meniscus lens 35 between the three lens system 36 and the sensor array 28, and the position of the aperture stop 31 at the front of assembly (therefore outside of the bounds of the lenses 32, 33, 34, 35), coupled with the chief ray CR striking the optical axis OA at the aperture stop 31, combine to provide enhanced performance and compact length. Stated another way, the focusing effect provided by the combination of the three lens system 36 and the negative meniscus 35 allows the length (distance L) from the front of the lens assembly 30 to the sensor array surface 28a to be reduced compared to prior art lens assemblies while still maintaining a sharp focusing/resolution of light from the field of view FV onto the sensor array surface 28a.

The four lenses 32-35 of the lens assembly 30 are supported in a cylindrical lens holder 37, which may be fabricated of metal or plastic. The lens holder 37, in turn is supported by a shroud 38 which extends from the printed circuit board 25. In addition to supporting the lens holder 37, the shroud protects the sensor array 28 from ambient illumination.

In addition to the reduced length (distance L) along the optical axis provided by the imaging lens assembly 30 of the present invention, the fact that aperture stop 31 is in the forwardmost position of the components of lens assembly 30 advantageously permits easy access to the aperture stop compared to prior art imaging lens assemblies wherein the aperture stop was located with a plurality of lenses on either side of the aperture stop. Access to the aperture stop 31 provides for ease of change of the aperture stop if desired. Changing the aperture size changes the F number of the imaging lens assembly 30 wherein F number=focal length/aperture diameter. Changing the aperture size does not change the field of view FV of the imaging assembly 12 however it does change the image quality/resolution of the imaging assembly 30 on the sensor array 28.

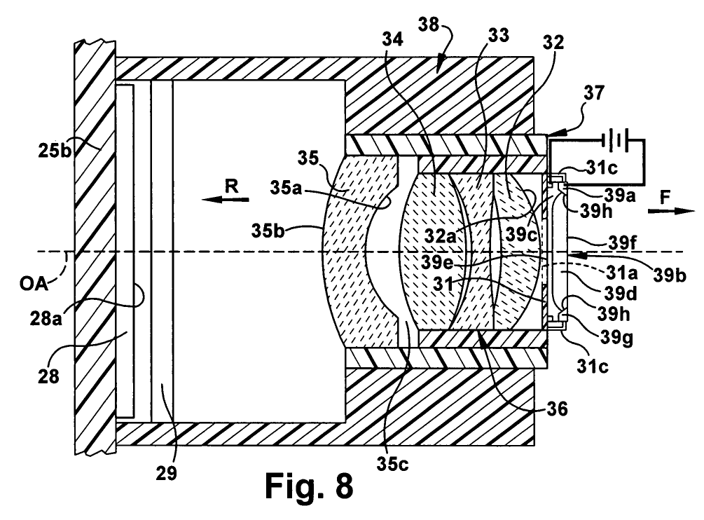

Additionally, access to the aperture stop 31 also allows for the addition of an additional optical element, such as an axicon lens 39a (FIG. 7) or liquid lens 39b (FIG. 8) which may advantageously be attached to the front of the lens assembly 30. The optical element 39a, 39b is affixed to a front side 31b of the aperture stop 31. It is desirable to locate the optical element 39a, 39b as close to the aperture stop 31 as possible to provide uniform performance of the element over the entire field of view FV. To facilitate attachment of the selected optical element 39a, 39b, the aperture stop 31 may include holder arms 31c that extend forward from the aperture stop front side 31b to secure the optical element 39a, 39b to the aperture stop 31.

An axicon lens 39a (shown in FIG. 7) is a lens which has a conical surface 39a′ and can be used to focus a parallel beam into a long focus depth thereby provided improved image resolution/sharpness of the imaged bar code 100′ at the sensor array surface 28a.

A liquid lens 39b (shown in FIG. 8) is lens formed by two liquids 39c, 39d of equal density that are sandwiched between two windows 39e, 39f in a conical shaped interior region defined by an conductive annular ring 39g that has a slanted interior wall 39h vessel. One liquid is typically water 39c and the other liquid is oil 39d. A voltage V is applied across the conductive ring 39. Since water 39c is electrically conductive, the greater the voltage applied to the ring 39g, the more water is attracted to and extends along the slanted interior wall 39h of the ring 39g. The migration of the water 39a along the interior wall 39h changes the shape of water-oil interface or boundary and thus the optical characteristics of the liquid lens. For example, at an applied voltage of zero volts, the water-oil boundary is flat. As applied voltage V increases, water 39c is attracted to the ring 39g and migrates along the wall 39h. This increase in volume of water 39c along the wall 39h causes the oil 39d to bow into a convex shape toward the middle of the lens, while the water 39c assumes a concave shape. This is convex-concave oil/water boundary is shown in schematic form in FIG. 8. The liquid lens 39b is used to provide enhanced focusing capabilities for the imaging lens system 30, particularly, use of the liquid lens 39b provides an acceptably sharp image of a target bar code to be focused on the sensor array 28 over a broad working range. The liquid lens 39b provides for a variable optical power (by changing applied voltage V) which, in turn, changes the effective focal distance of the lens assembly 30.

While the present invention has been described with a degree of particularity, it is the intent that the invention all modifications and alterations from the disclosed design falling with the spirit or scope of the appended claims.

I claim:

1. An imaging lens assembly for a camera assembly of an imaging-based bar code reader for focusing an image of a target object within a field of view of the camera assembly onto a sensor array of the camera assembly, the imaging lens assembly comprising:
a front aperture stop facing the field of view of the camera assembly, the aperture stop including an aperture through which light from the field of view passes;
a three lens system disposed rearward of the front aperture stop, the three lens system including a first lens closest to the front aperture stop having an overall positive optical power, second middle lens having an overall negative optical power and a third lens having an overall positive optical power; and
a meniscus lens disposed rearward of the three lens system having an overall negative optical power, a curvature of a forward facing optic surface facing the three lens system being different than a curvature of a rearward facing optic surface, the three lens system and the negative meniscus lens receiving light passing through the aperture and focusing the light onto the sensor array.

2. The imaging lens assembly of claim 1 wherein a radius of curvature of the forward facing optic surface of the meniscus lens is less than a radius of curvature of the rearward facing optic surface.

3. The imaging lens assembly of claim 1 wherein the meniscus lens is fabricated of crown glass.

4. The imaging lens assembly of claim 1 wherein the three lens system includes a first lens closest to the aperture stop, the first lens being convex-concave.

5. The imaging lens assembly of claim 1 wherein the three lens system includes a second middle lens disposed between a first lens closest to the aperture stop and a third lens closest to the meniscus lens, the second lens being biconcave.

6. The imaging lens assembly of claim 1 wherein the three lens system includes a third lens closest to the meniscus lens, the third lens being biconvex.

7. The imaging lens assembly of claim 1 wherein a first lens closest to the aperture stop and a third lens closest to the sensor array of the three lens system are fabricated of crown glass and a second lens of the three lens system is fabricated of flint glass.

8. The imaging lens assembly of claim 1 wherein there is an air gap between the meniscus lens and the three lens system.

9. The imaging lens assembly of claim 1 wherein an axicon lens is positioned adjacent a forward facing side of the aperture stop.

10. The imaging lens assembly of claim 1 wherein an axicon lens is positioned adjacent a forward facing side of the aperture stop.

11. An imaging-based bar code reader comprising:
an imaging system including camera assembly including an imaging lens assembly and a sensor array for focusing an image of a target object within a field of view of the camera assembly onto the sensor array;
the imaging lens assembly including:
a front aperture stop facing the field of view of the camera assembly, the aperture stop including an aperture through which light from the field of view passes;
a three lens system disposed rearward of the front aperture stop, the three lens system including a first lens closest to the front aperture stop having an overall positive optical power, second middle lens having an overall negative optical power and a third lens having an overall positive optical power; and
a meniscus lens disposed rearward of the three lens system having an overall negative optical power, a curvature of a forward facing optic surface facing the three lens system being different than a curvature of a rearward facing optic surface, the three lens system and the negative meniscus lens receiving light passing through the aperture and focusing the light onto the sensor array.

12. The imaging-based bar code reader of claim 11 wherein a radius of curvature of the forward facing optic surface of the meniscus lens is less than a radius of curvature of the rearward facing optic surface.

13. The imaging-based bar code reader of claim 11 wherein the meniscus lens is fabricated of crown glass.

14. The imaging-based bar code reader of claim 11 wherein the three lens system includes a first lens closest to the aperture stop, the first lens being convex-concave.

15. The imaging-based bar code reader of claim 111 wherein the three lens system includes a second middle lens disposed between a first lens closest to the aperture stop and a third lens closest to the negative meniscus lens, the second lens being biconcave.

16. The imaging-based bar code reader of claim 11 wherein the three lens system includes a third lens closest to the negative meniscus lens, the third lens being biconvex.

17. The imaging-based bar reader of claim 11 wherein a first lens closest to the aperture stop and a third lens closest to the sensor array of the three lens system are fabricated of crown glass and a third lens of the three lens system is fabricated of flint glass.

18. The imaging-based bar reader of claim 11 wherein there is an air gap between the meniscus lens and the three lens system.

19. The imaging-based bar reader of claim 11 wherein an axicon lens is positioned adjacent a forward facing side of the aperture stop.

20. The imaging-based bar reader of claim 11 wherein a liquid lens is attached to a forward facing side of the aperture stop.

21. A method of imaging a target object, the steps of the method including:
providing an imaging system including camera assembly including an imaging lens assembly and a sensor array for focusing an image of a target object within a field of view of the camera assembly onto the sensor array;
providing the imaging lens assembly including: a front aperture stop facing the field of view of the camera assembly, the aperture stop including an aperture through which light from the field of view passes; a three lens system disposed rearward of the front aperture stop, the three lens system including a first lens closest to the front aperture stop having an overall positive optical power, second middle lens having an overall negative optical power and a third lens having an overall positive optical power; and a meniscus lens disposed rearward of the three lens system having an overall negative optical power, a curvature of a forward facing optic surface facing the three lens system being different than a curvature of a rearward facing optic surface, the three lens system and the negative meniscus lens receiving light passing through the aperture and focusing the light onto the sensor; and
energizing imaging system and imaging the target object.

22. An imaging lens assembly for a camera assembly of an imaging-based bar code reader for focusing an image of a target object within a field of view of the camera assembly onto a sensor array of the camera assembly, the imaging lens assembly comprising:
a front aperture stop means facing the field of view of the camera assembly, the aperture stop including an aperture through which light from the field of view passes;
a three lens system means disposed rearward of the front aperture stop; and
a meniscus lens means disposed rearward of the three lens system wherein the three lens system and the meniscus lens receiving light passing through the aperture and focusing the light onto the sensor array.
